(19) United States
(12) Patent Application Publication
(10) Pub. No.: US 2011/0133486 A1
(43) Pub. Date: Jun. 9, 2011

(54) Electromagnetic Hybrid Rotary Engine

(76) Inventor: Chad Maglaque, Seattle, WA (US)

(21) Appl. No.: 12/631,951

(22) Filed: Dec. 7, 2009

(51) Int. Cl. H02K 7/18

(52) U.S. Cl. 290/1 R

(57) ABSTRACT

An engine includes a rotary piston slideably disposed an epitrochoid-shaped housing forming one or more rotor chambers between the rotary piston and the housing wall. The engine further includes a converter operable with the rotary piston to convert mechanical energy of the rotary piston to electrical energy in the converter in a stroke and convert electrical energy of the converter to mechanical energy in the rotary piston in at least one other stroke.

### SUMMARY

In one aspect, an internal combustion rotary engine includes a first rotary piston slideably disposed in an epitrochoid-shaped first rotor housing forming one or more rotor chambers between the first rotary piston and the first rotor housing wall, a first eccentric lobe passing through the center of the first rotary piston which may be configured to rotate freely inside the first rotary piston to form a first rotor assembly, a first intake port configured to admit a reactant to the first rotor housing which may be configured to be closed either by occlusion by the rotating first rotary piston or by a valve which may be configured to open and close at select times during the rotary piston cycle via a camshaft which may in turn be configured to be rotated by an electromagnetic actuator such as a stepper motor or the valve may be mechanically or electronically actuated by the first piston, a first exhaust port configured to exhaust a reaction product from the first rotor housing which may be configured to be closed either by occlusion by the rotating first rotary piston or by a valve which may be configured to open and close at select times during the rotary piston cycle via a camshaft which may in turn be configured to be rotated by an electromagnetic actuator such as a stepper motor or the valve may be mechanically or electronically actuated by the first piston, and a first power converter operable with the first rotor assembly to convert mechanical energy of the first rotor assembly to and from electrical energy. Depending on the embodiment, the first rotor assembly may be connected to a crankshaft. The first rotor assembly may be configured to rotate in the first rotor housing by gas pressure, by magnetic force, etc. The first power converter may be configured to convert mechanical energy of the first rotor assembly to electrical energy during a power stroke, and to drive the first rotor assembly during any or all of an exhaust stroke, an intake stroke, or a compression stroke. The first rotor assembly may include a magnetic element (e.g., an electromagnet, a permanent magnet or a reaction plate) and the first power converter may include an armature configured to generate electric current in response to movement of the magnetic element or to move the magnetic element by driving electric current through a coil. The first power converter may include a plurality of coils, in which case a first subset of the plurality may be operable to convert electrical energy to mechanical energy of the rotor assembly, and a second subset to convert mechanical energy of the rotor assembly to electrical energy. The first rotor assembly may include an armature or reaction plate configured to interact with a magnetic field through a variable reluctance or variable inductance magnetic circuit to convert rotary movement to and from electrical energy. The first rotor assembly may be coupled to a mechanism that may include a magnetic element, and the power converter an armature that operates with the magnetic element to convert rotation of the magnetic element to and from electrical energy. The mechanism may include an armature that interacts with a variable reluctance or variable inductance magnetic circuit to convert rotary movement to and from electrical energy. The first rotor assembly may be operably linked to an active material element (e.g., piezoelectric, magnetostrictive, electrostrictive, or shape memory material) that is configured to respond to applied force to generate electrical energy.

The engine may further include a thermal controller that acts to limit thermal excursions of all or a portion of the engine (e.g., a cooling system or insulation).

The engine may further include a reaction trigger (e.g., an electrical igniter such as a spark plug, a thermal igniter, a chemical igniter, a catalyst, a hypergolic injector, particle beam igniter, or a plasma injector) configured to initiate a chemical reaction in a reactant disposed in the first rotor chamber formed between the first rotary piston and the first rotor housing wall. The reaction trigger may be disposed at the first rotor housing wall, on the first rotary piston, or elsewhere. The reaction trigger may draw power from the first power converter, may be electrically coupled to the first power converter, may draw power from an energy management system coupled to the first power converter, or may draw power from elsewhere.

The engine may further include a carburetor configured to deliver a reactant mixture to the first intake port. The engine may include an injector (e.g., a fuel injector or a liquid reactant injector) configured to deliver a reactant to the first rotor housing via the first intake port. The first intake port may be configured to admit fuel, oxidizer, a mixture thereof, or a reactant mixture to the first rotor housing, or first and second reactants (e.g., fuel and oxidizer) may be admitted through a first and a second intake port, respectively.

The engine may further include an energy management system electrically coupled to the first power converter, which may include an energy storage device such as a battery, capacitor, inductor, or mechanical energy storage device, in which case converting the mechanical energy of the first rotor assembly to electrical energy as the first rotary piston rotates may include transferring electrical energy to the energy management system, or drawing electrical energy from the energy management system to the power converter to rotate the first rotor assembly in the first rotor housing.

The engine may further include a second rotor assembly slideably disposed in a second epitrochoid-shaped rotor housing, in which case the first and second rotor assembly may be configured for asynchronous or synchronous rotation, or may be coupled to a common or to separate crankshafts. The engine may be configured to run in a first mode in which a chemical reaction drives only the first rotor assembly and in a second mode in which a chemical reaction drives the first rotor assembly and the second rotor assembly, in which case the engine may select between the first and second modes in response to actual or predicted operating conditions. The engine may also be configured to determine a velocity profile of a rotor assembly or duration of a rotary piston stroke, an operating frequency of a rotor assembly in response to operating conditions. In any of these cases, operating conditions may include incline, temperature, current draw, speed, acceleration, braking, load, fuel composition, engine emissions, power, local rules, or engine settings.

In another aspect, a method of operating an internal combustion rotary engine (including a first rotor assembly slideably disposed in a epitrochoid-shaped first rotor housing and a first power converter operable with the first rotor assembly to convert mechanical energy of the rotor assembly to and from electrical energy) includes introducing a reactant into the first rotor housing, applying electrical energy to the first power converter to rotate the first rotor assembly in the first rotor housing (optionally compressing the introduced reactant), triggering a chemical reaction of the introduced reactant, thereby transforming chemical potential energy to mechanical energy of the first rotor assembly, and converting the mechanical energy of the first rotor assembly to electrical energy via the first power converter. The method may further include applying electrical energy to the power converter to rotate the first rotor assembly after triggering the chemical reaction. Compressing the introduced reactant may include compressing the reactant substantially adiabatically or isothermally.

Triggering the chemical reaction may include triggering the chemical reaction when the first rotor assembly is in a selected position, for example by generating an energy discharge such as a spark, by thermal ignition, by chemical ignition, by exposure to a catalyst, by hypergolic injection, exposure to a particle beam, or by plasma injection, or may include slowing or holding the first rotor assembly substantially still during the chemical reaction (e.g., by applying a force to the first rotor assembly via the power converter), in which case the first rotor assembly may be released when the chemical reaction is substantially complete. The chemical reaction may produce a reaction product, and converting mechanical energy of the first rotor assembly to electrical energy may include substantially adiabatically expanding the reaction product. The introduced reactant may include fuel (e.g., hydrogen, hydrocarbon fuel, etc.) or an oxidizer (e.g., oxygen, air, etc.), which may be introduced separately or mixed, or it may include a decomposing reactant. The method may further include exhausting a reaction product from the first rotor housing, for example by rotating the first rotary piston past the occluded exhaust port.

The internal combustion rotary engine may further include a second rotor assembly slideably disposed in a second epitrochoid-shaped rotor housing, in which case the method may further include triggering a chemical reaction in the second rotor housing at substantially the same time the chemical reaction is triggered in the first rotor housing. The method may include triggering a chemical reaction in the second rotor housing at a substantially similar or at a different operating frequency from the first rotor housing. The method may also include determining whether to trigger the chemical reaction in the second rotor housing at least in part on the basis of an actual or predicted operating condition (e.g., incline, temperature, current draw, speed, acceleration, braking, load, fuel composition, engine emissions, power, local rules, or engine settings). The method may include determining a velocity profile of the first rotor assembly, duration of the first rotary piston stroke, or an operating frequency for the first rotor assembly based at least in part on an actual or predicted operating condition (e.g., incline, temperature, current draw, speed, acceleration, braking, load, fuel composition, engine emissions, power, local rules, or engine settings). Introducing reactant into the first rotor housing may include introducing the reactant when the first rotary piston is in a selected position, or it may include opening an intake valve (e.g., by rotating a camshaft or electronically triggering opening).

In yet an additional aspect, a method of retrofitting for electrical power generation an internal combustion rotary engine (including a plurality of rotor assemblies connected to a common crankshaft) includes applying to at least one and optionally to each rotor assembly a power converter fixed to the rotor housing and operable to convert mechanical energy of the rotor assembly to and from electrical energy. The method may further include disconnecting the rotor assemblies from the crankshaft. The method may include applying a magnetic element (e.g., an electromagnet, a permanent magnet or a reaction plate) to each rotor assembly, wherein the power converter includes an armature operable with the magnetic element to apply force to the rotor assembly. The armature may be operable with the magnetic element to generate electric current in response to movement of the magnetic element. The method may further include applying a thermal controller that acts to limit thermal excursions of all or a portion of the engine (e.g., a cooling system or insulation). The power converter may be electrically coupled to an energy management system, which may include an energy storage device such as a battery, capacitor, inductor, or mechanical energy storage device. The engine may include an electrically powered reaction trigger, in which case the method may include electrically coupling the energy management system to the electrically powered reaction trigger.

The power converter may be electrically coupled to a control system, which may be configured to drive the rotor assemblies synchronously (including in a configuration in which the crankshaft is removed and substantially the same relative phase relationship of the rotor assemblies is maintained by the control system) or asynchronously. The control system may be configured to determine whether to drive a selected rotor assembly, a velocity profile of a rotor assembly, duration of a rotary piston stroke, or an operating frequency of a rotor assembly in response to a determined operating condition (e.g., incline, temperature, current draw, speed, acceleration, braking, load, fuel composition, engine emissions, power, local rules, or engine settings). Applying the power converter may include coupling the rotor assembly to a mechanism that may include a magnetic element (e.g., an electromagnet,a permanent magnet or a reaction plate) and the converter an armature that operates with the magnetic element to convert rotation of the magnetic element to and from electrical energy. The mechanism may include an armature that interacts with a variable reluctance or variable inductance magnetic circuit to convert rotary movement to electrical energy. The power converter may be configured to drive the rotor assembly during an intake stroke, an exhaust stroke, and a compression stroke, and to convert mechanical energy of the rotor assembly to electrical energy during a power stroke.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF FIGURES

Various embodiments of the present invention are described herein by way of example in conjunction with the following figures, wherein:

FIG. 1 is a schematic of an electromagnetic rotary engine assembly with three rotor chambers.

FIG. 2 is a schematic of an electromagnetic rotary engine assembly with a single rotor chamber.

FIG. 3 is a schematic of a coupled eccentric lobe assembly around a fixed shaft and power converter.

FIG. 4 is a schematic of an eccentric lobe assembly coupled to a crankshaft with a fixed power converter.

FIG. 5 is a schematic of an eccentric lobe and power converter assembly coupled to a crankshaft.

FIG. 6 is a schematic of an eccentric lobe assembly coupled to a crankshaft that rotates around a power converter.

FIG. 7 illustrates the position of a rotor assembly in a rotor housing during a four-stroke rotary piston cycle.

FIG. 8 is a schematic of a conventional rotary engine before retrofit.

FIG. 9 is a schematic of a coupled eccentric lobe assembly and fixed shaft and power converter after retrofit.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The term “valve,” as used herein, includes any actuated flow controller or other actuated mechanism for selectively passing matter through an opening, including without limitation ball valves, plug valves, butterfly valves, choke valves, check valves, gate valves, leaf valves, poppet valves, rotary valves, slide valves, solenoid valves, 2-way valves, or 3-way valves. Valves may be actuated by any method, including without limitation by mechanical, electrical, magnetic, camshaft-driven, hydraulic, or pneumatic means. “Valve timing” refers to any system of opening or closing valves in a specified temporal pattern relative to one another or to an engine component. For example, an intake valve may be configured to open before or during an intake stroke, and to close before a compression stroke.

The term “port,” as used herein, includes any opening or set of openings (e.g., a porous foam) which may admit mass (solid, liquid, gas, or plasma) in one or more directions. Ports may be, but need not be, opened and closed by valves.

The term “bearing,” as used herein, includes any part of a machine on which another part moves, slides, or rotates, including without limitation slide bearings, flexure bearings, ball bearings, roller bearings, gas bearings, or magnetic bearings.

The term “permanent magnet,” as used herein, includes magnetizable materials that have been polarized to induce a persistent magnetic field. The term “permanent” should not be construed to require that a permanent magnet may not be demagnetized either intentionally or accidentally.

The term “armature,” as used herein, includes any structure that interacts with a magnetic field via variable inductance (such as a reaction plate using non-ferrous metals such as aluminum and copper) or variable reluctance to do work (positive or negative) on the armature.

The term “magnetic element,” as used herein, includes an electromagnet, a permanent magnet, a magnetically susceptible material such as an iron core, an armature or reaction plate that interacts with a magnetic field via variable inductance or variable reluctance.

The term “reactant,” as used herein, includes any material or combination of materials that can be induced to transform chemical potential energy to mechanical energy, for example to chemically react and drive a rotary piston (typically by forming an expanding gas upon reaction). As used herein, a “fuel” is a particular type of reactant that reacts with an oxidizer to drive a rotary piston. Fuels include, but are not limited to, hydrocarbon fuels such as gasoline, diesel, biodiesel, kerosene, propane, and butane, alcohol fuels such as ethanol, methanol, and butanol, and mixtures of any of the above. Other suitable reactants include decomposing reactants such as hydrazine (which may decompose to ammonia and nitrogen) or hydrogen peroxide (which may decompose to water and oxygen). The term “reaction products,” as used herein, includes any material remaining after a reaction, including without limitation chemically reacted material, excess reactant which has not reacted or has only partially reacted, or any inert material which may be mixed with a reactant. A “substantially complete” reaction is one in which substantially all of at least one of the reactants has been consumed, or which has been substantially slowed or stopped by other factors such as changing temperature or pressure.

The term “carburetor,” as used herein, includes a mechanism for mixing reactants (e.g., for mixing fuel and oxidizer) prior to their delivery to a cylinder.

The term “rotary piston cycle,” as used herein, includes any series of rotary piston movements which begin and end with the rotary piston in substantially the same configuration. In a four-stroke rotary piston cycle, the cycle may include an intake stroke, a compression stroke, a power stroke, and an exhaust stroke. Additional or alternate strokes may form part of a rotary piston cycle as described elsewhere herein. The term “operating frequency,” as used herein, is the reciprocal of the time required to complete a single rotary cycle. The term “frequency” should not be construed to limit rotary piston operations to regular intervals.

The term “eccentric lobe cycle,” as used herein, includes any series of eccentric lobe movements which begin and end with the eccentric lobe in substantially the same configuration.

The term “active material,” as used herein, includes materials that may be induced to change their mechanical configuration by an applied environmental change, including without limitation piezoelectric, magnetostrictive, electrostrictive or shape-memory materials.

In general, terms used herein should be read to have their ordinary and common meanings as understood by one of ordinary skill in the art in view of the descriptions provided herein.

A variety of rotor assemblies are described herein for use in internal combustion rotary engines, in which mechanical energy of a rotary piston (e.g., kinetic energy of a rotary piston) is converted to electrical energy. In some embodiments, these assemblies may be well-adapted to be installed in vehicles, for example in electric vehicles. In other embodiments, these assemblies may be appropriate for use in stationary or portable generators, which transform chemical energy into electrical energy (e.g., by burning a fuel).

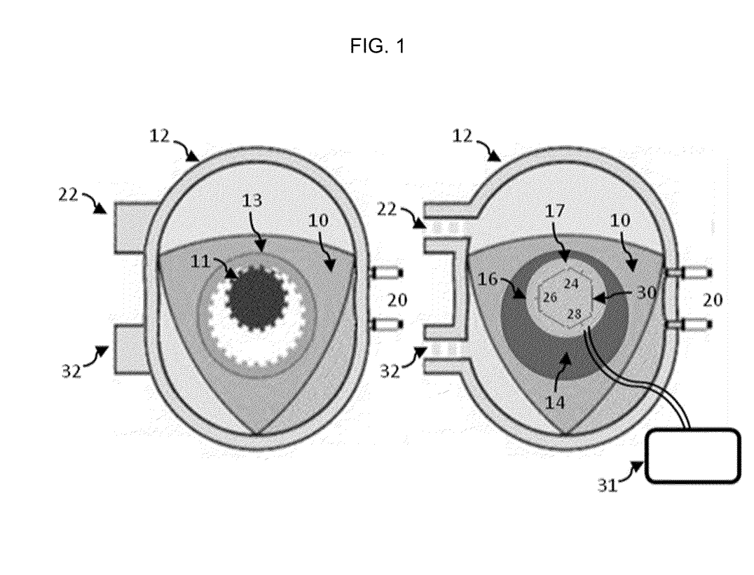

FIG. 1 is a schematic of one embodiment of an electromagnetic rotary engine assembly with multiple rotor chambers. Rotary piston 10 is slideably disposed in a rotor housing 12. With an attached ring gear 13, rotary piston 10 revolves around a fixed gear 11 attached to the rotor housing end face (not shown). An eccentric lobe 14 rotates around a fixed shaft 17 supported by bearings (not shown) and passes through the center of the rotary piston 10 and is configured to rotate freely inside rotary piston 10′supported by bearings (not shown). The eccentric lobe 14 includes a magnetic element 16, which is positioned to rotate around power converter coils 24, 26, and 28 mounted to fixed shaft 17, which together form the power converter 30. The eccentric lobe 14, and in turn rotary piston 10, can be rotated in either direction by application of a voltage to the power converter 30. In addition, the power converter 30 is configured to convert mechanical energy of the rotary piston 10, and in turn eccentric lobe 14, to electrical energy. This energy may be stored, for example, in a battery, capacitor, or other energy management system (not shown).

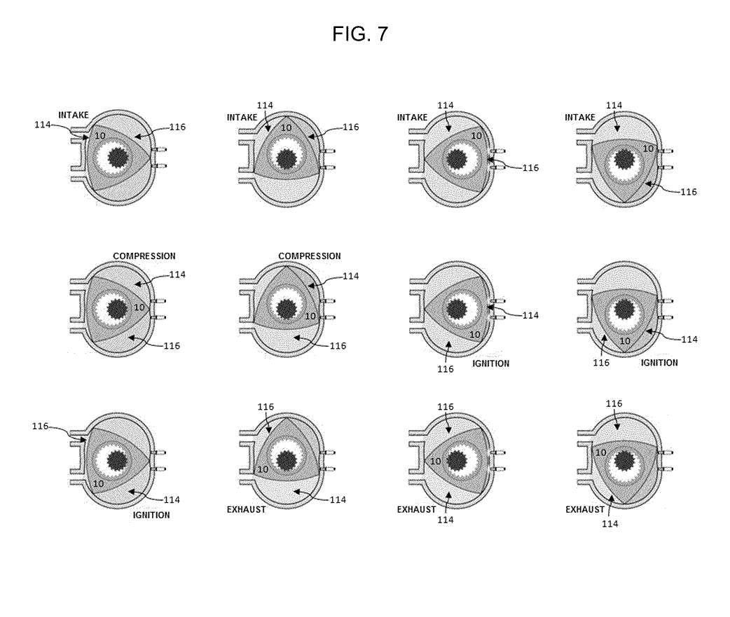

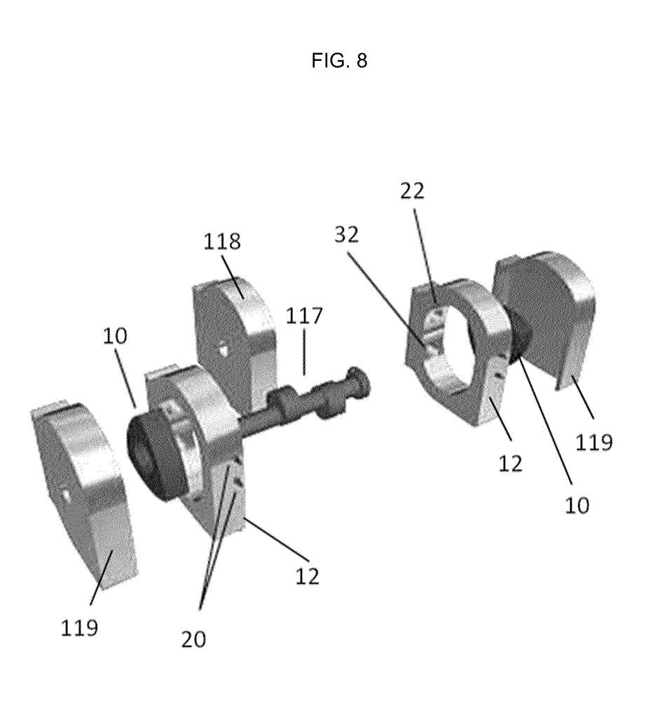

Intake port 22 allows a fuel-oxidizer mixture supplied by a carburetor (not shown) to enter the rotor chamber when the apex of rotary piston 10 passes over the intake port 22 and rotary piston 10 rotates past the intake port 22 toward a rotor chamber of increasing volume (the “intake stroke”—see FIG. 7 for more detail on the movement of the rotor assembly within the rotor housing). In the illustrated embodiment, a simple intake port structure is shown, but other embodiments may include fuel injectors or other devices for introducing a reactant into the cylinder. Motion of rotary piston 10 past the intake port 22 may be driven by application of a voltage to power converter 30, which induces an electromotive force on the magnetic element 16. The fuel-oxidizer mixture is compressed by further rotation of the rotary piston 10 toward a rotor chamber of decreasing volume (the “compression stroke”—see FIG. 7 for more detail on the movement of the rotor assembly within the rotor housing), which may be driven by applying a voltage to power converter 30, which induces an electromotive force on the magnetic element 16. The compressed fuel-oxidizer is ignited by spark plugs 20, thereby driving the rotary piston 10 toward a rotor chamber of increasing volume (the “power stroke—see FIG. 7 for more detail on the movement of the rotor assembly within the rotor housing). The illustrated embodiment includes spark plugs 20, but other ignition sources may be used such as those described elsewhere herein, or the engine may be operated without an ignition source using reactants that spontaneously react at the end of the compression stroke. During the power stroke, magnetic element 16 rotates around the power converter 30, inducing a voltage in the power converter coils 24, 26, and 28. This voltage may be used to charge a battery, capacitor, or other energy management system as describe elsewhere herein. Once the power stroke is completed, rotary piston 10 may be driven by applying a voltage to power converter 30, thereby inducing an electromotive force on magnetic element 16. As the apex of rotary piston 10 passes over the exhaust port 32 and the rotary piston 10 rotates toward a rotor chamber of decreasing volume, reaction products from the reaction of the fuel and oxidizer are exhausted through exhaust port 32 (the “exhaust stroke”—see FIG. 7 for more detail on the movement of the rotor assembly within the rotor housing). In the illustrated embodiment, no intake or exhaust valves are used, but other valving systems may also be used and driven by any convenient method, including by an electric activator such as a stepper motor or a torque motor. In some embodiments, control of the valves may be integrated with the energy management system described elsewhere herein, and power may be supplied to the valves by the energy management system.”). In the illustrated embodiment, a simple intake port structure is shown, but other embodiments may include intake ports can be placed elsewhere within the rotor housing, for example, on rotor housing end faces 118 and 119 depicted in FIG. 8.

As described, the rotary piston rotates during an intake stroke, in which at least one reactant is brought into the engine. In some embodiments, one or more reactants may be at or near ambient pressure, and may be drawn into the rotor housing by a partial vacuum produced by the rotary piston motion in the rotor housing, while in other embodiments, the reactants may be injected or otherwise introduced into the rotor housing, for example under pressure. Reactants may be supplied in any suitable form, including without limitation as a gas or as a liquid. The reactant(s) are then compressed by motion of the rotary piston during compression stroke. A chemical reaction is triggered in the compressed reactant(s), which drives the rotary piston in power stroke. Finally, the rotary piston returns to its original position in the exhaust stroke, exhausting some or all of any reaction products from the rotor housing.

In the illustrated embodiment, the intake stroke, compression stroke, and exhaust stroke are all driven by the power converter. In other embodiments, one or more of these strokes may be driven by other means, for example, by a crankshaft and flywheel, a spring (e.g., a mechanical spring or a gas spring), an active material component, or a power stroke of an opposed cylinder. Driving a rotary piston “during” a stroke includes driving it for only a portion of its total travel during the stroke.

In the illustrated embodiment, the operation of power converter 30 is controlled by a controller 31, which may be analog, digital, or computer-based. Controller 31 determines the sign and magnitude of energy transfer through power converter 30 based on external inputs and on the present and past states of one or more of the rotary piston 10, rotor housing 12, and other engine components. These states may be inferred, for example, from measurement of the current through or voltage across the coils or active elements in the power converter 30, or may be measured by one or more sensors (not shown), which may detect, among other possible parameters, the position, velocity, stroke duration, or acceleration of the rotary piston 10 or eccentric lobe 14, or the pressure, temperature, density, mass, or chemical makeup of any reactants in the rotor housing 12. These sensors may use electromagnetic, electrochemical, optical, electromechanical, or other means of sensing the relevant parameter. For example, a fixed coil and rotor-mounted magnet separate from the power converter may be used to sense the position and velocity of the rotary piston, a piezoelectric sensor may be used to sense the pressure in the rotor housing, and a fiber-optically coupled spectrometer may detect light from inside the cylinder to sense the state of combustion of fuel and oxidizer. Any of these sensor outputs may feed directly or indirectly into controller 31. Controller 31 may also interface with an energy management system (not shown) as described elsewhere herein.

In the illustrated embodiment, a fuel-oxidizer mixture is ignited by firing spark plugs 20. In other embodiments, a different reactant or reaction trigger may be used. For example, instead of a spark plug, another type of electrical igniter, a thermal igniter (e.g., a glow plug), a chemical igniter (e.g., a squib), a photo-igniter (e.g., a photochemical igniter, a photothermal igniter, a photoplasmic igniter, or a laser igniter), a catalyst, a hypergolic injection, a particle beam (e.g., an electron beam or an ion beam), or a plasma injection may trigger the chemical reaction. In other embodiments, the reaction trigger mechanism may be absent, and the reaction may be triggered by compression of the reactants as the rotary piston 10 moves through the compression stroke. In addition, the chemical reaction that drives the power stroke need not involve a fuel-oxidizer reaction, but may be any reaction that produces an expanding gas or other reaction product that will drive rotary piston 10, and in turn eccentric lobe 14, in a power stroke (e.g., an energetic decomposition). The reaction trigger may also be disposed in a different location, for example on a wall of rotor housing 12 or on rotary piston 10. In the case of a powered reaction trigger (e.g., a spark plug or a plasma injection), in some embodiments power for the reaction trigger may be provided by the energy management system that stores power from the power stroke.

In the illustrated embodiment, the introduced reactant is a fuel-oxidizer mixture. In other embodiments, other reactants, such as other suitable mixtures or decomposing reactants, may be used. In some embodiments, reactant(s) may be in condensed form (e.g., liquid or solid form). For example, the rotor housing assemblies described herein may be well-suited for use in an extraterrestrial vehicle (e.g., a moon buggy) or an underwater vehicle (e.g., a submarine or a torpedo), in which cases condensed reactants may be preferred (e.g., liquid fuel and liquid oxidizer). In some embodiments, liquid reactant(s) may be vaporized before reaction. When reactant(s) are in condensed form, the “compression stroke” may in some embodiments compress the reactant(s) by applying a compressive force without substantially changing reactant volume. In other embodiments, the “compression stroke” may simply reduce the volume of the reaction chamber, without substantially affecting the reactants within.

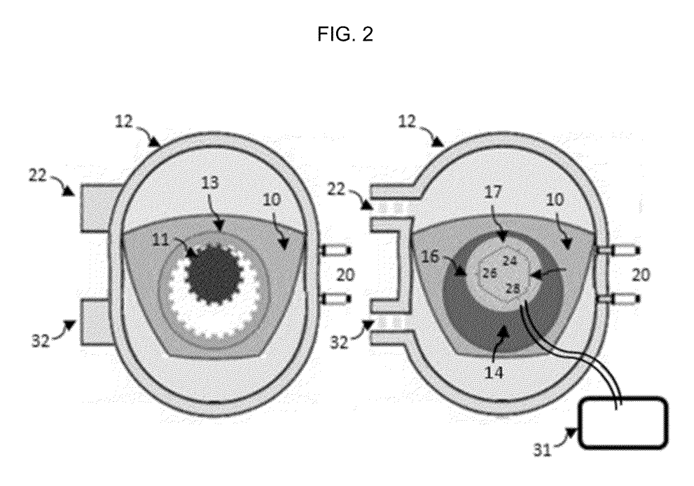

FIG. 2 is a schematic of one embodiment of an electromagnetic rotary engine assembly with a single rotor chamber. The components and operation of the engine assembly is the same as described in the previous embodiment, the only difference being the number rotor chambers formed by the rotor assembly at any one time.

FIG. 1-FIG. 2 all show a spark plug 20 that ignites a fuel-oxidizer mixture (e.g., a fuel-air mixture). Other ignition sources may be substituted in any of the embodiments described herein, such as other electrical igniters, photoigniters, thermal igniters, chemical igniters, catalysts, hypergolic injections, particle beams, or plasma injections. In other embodiments, no ignition source may be required, and compression may be sufficient to initiate a reaction. In addition, the chemical reaction that drives the power stroke need not involve a fuel-oxidizer reaction, but may be any reaction that produces an expanding gas or other reaction product that will drive rotary piston 10 in a power stroke (e.g., an energetic decomposition).

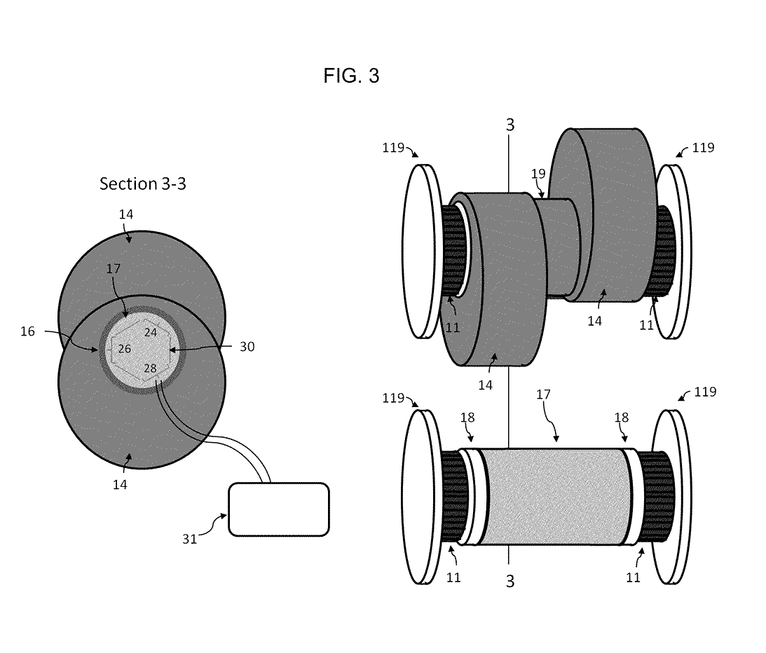

FIG. 3 is a schematic of another embodiment of an eccentric lobe assembly coupled around a fixed shaft. In the illustrated embodiment, two eccentric lobes 14 are connected to a coupling 19 that spin freely around a fixed shaft 17 supported by bearings 18. Fixed gears 11 and around which the rotor assemblies revolve (rotary pistons not shown for viewing simplicity) are mounted to the rotor housing end faces 119 (a cutaway view of the rotor housing end faces are provided for viewing simplicity). The coupling 19 or the eccentric lobes 14 themselves includes magnetic element 16 which is interoperable with power converter 30 mounted to fixed shaft 17 and induces a voltage in the power converter 30 during the power stroke (for example, during all or a portion of the power stroke). The power converter 30 may also, for example, drive the coupling 19 and eccentric lobes 14, and in turn the rotor assembly, during any or all of an exhaust stroke, an intake stroke, or a compression stroke. In the illustrated embodiment, the operation of power converter 30 is controlled by a controller 31 as described herein. Coupling 19 may, for example, act to control rotor assembly timing (rotary pistons not shown for viewing simplicity) or valve timing.

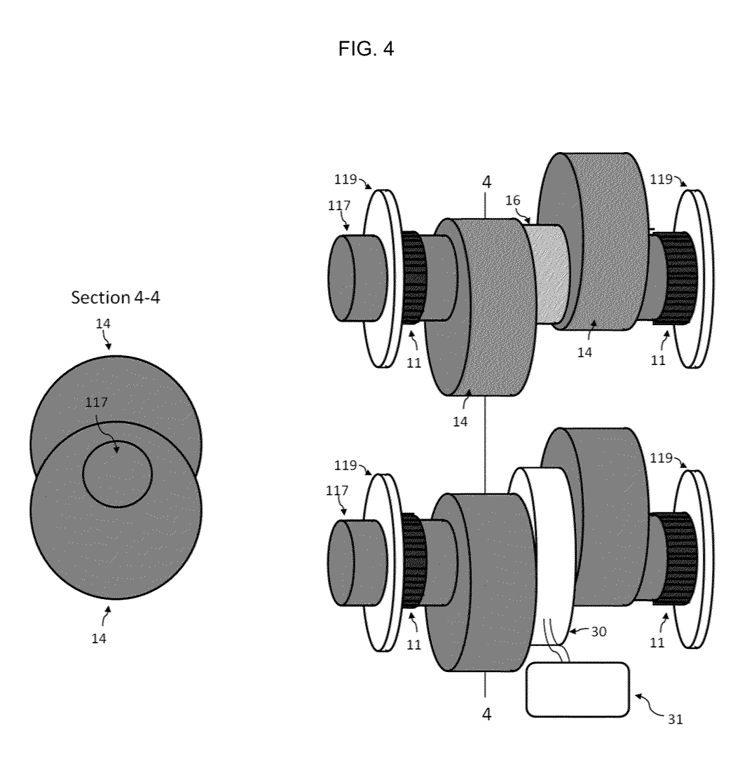

FIG. 4 is a schematic of another embodiment of an eccentric lobe assembly coupled to a crankshaft. In the illustrated embodiment, two eccentric lobes 14 are coupled to a crankshaft 117 that spins freely inside two fixed gears 11 which serve as bearing supports, and around which the rotor assembly revolves (rotary piston not shown for viewing simplicity). The fixed gears 11 are mounted to the rotor housing end faces 119 (a cutaway view of the rotor housing end faces are provided for viewing simplicity). The crankshaft 117 includes magnetic element 16 is positioned to rotate either inside or beside the fixed power converter 30 and to be operable with power converter 30 and induces a voltage in the power converter 30 during the power stroke (for example, during all or a portion of the power stroke). This voltage may be used to charge a battery, capacitor, or other energy management system as describe elsewhere herein.

Those skilled in the art will recognize that other rotary electromagnetic converters may be substituted for power converter 30 illustrated in FIG. 4. For example, instead of magnetic element 16 positioned to rotate either inside or beside the fixed power converter 30, an external magnetic element (not shown) such as a permanent magnet or an electromagnet imposing a magnetic field upon eccentric lobe 14 and when eccentric lobe 14 turns in response to rotation of a rotor assembly during the power stroke, generates a voltage between crankshaft 117 and the outside of eccentric lobe 14 (that is, the eccentric lobe and the magnetic element form a homopolar generator). A power converter 30 may use this voltage to charge a battery, capacitor, or other power management system as disclosed elsewhere herein. During the intake, compression, and exhaust strokes, a power converter 30 may apply a voltage between crank shaft 117 and the outside of eccentric lobe 14, thereby inducing an electromotive force to turn eccentric lobe 14 and drive the crankshaft and one or more rotor assemblies. In the illustrated embodiment, the operation of a power converter 30 is controlled by a controller 31 as described herein.

Crankshaft 117 may, for example, act to control rotor assembly timing (rotary pistons not shown for viewing simplicity) or valve timing, may act to provide some or all of the driving force for at least one of the intake, compression, or exhaust strokes, or may convert at least a portion of the energy of the power stroke to mechanical energy (e.g., to drive a gear).

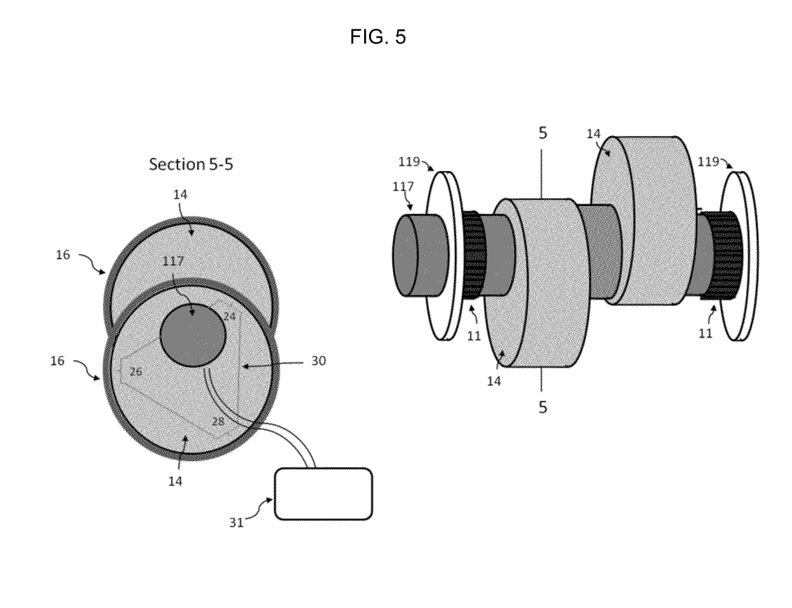

FIG. 5 is a schematic of another embodiment of an eccentric lobe assembly coupled to a crankshaft. In the illustrated embodiment, two eccentric lobes 14 are coupled to a crankshaft 117 that spins freely inside two fixed gears 11 which serve as bearing supports, and around which the rotor assembly revolves (rotary piston not shown for viewing simplicity). The fixed gears 11 are mounted to the rotor housing end faces 119 (a cutaway view of the rotor housing end faces are provided for viewing simplicity). The rotary pistons (not shown) include magnetic element 16 which is interoperable with power converter 30 mounted to eccentric lobe 14 which induces a voltage in the power converter 30 when eccentric lobe 14 and rotary piston (not shown) rotate relative to one another, converting mechanical energy of the rotating converter to and from electrical energy. Power converter 30 may then use this electrical energy to charge or draw power from a battery, capacitor, or other power management system as described elsewhere herein. In the illustrated embodiment, power converter 30 may be coupled to a controller 31 while rotating using commutation (not shown) or a similar method to maintain electrical continuity between the controller 31 and power converter 30. The operation of power converter 30 is controlled by a controller 31 as described elsewhere herein.

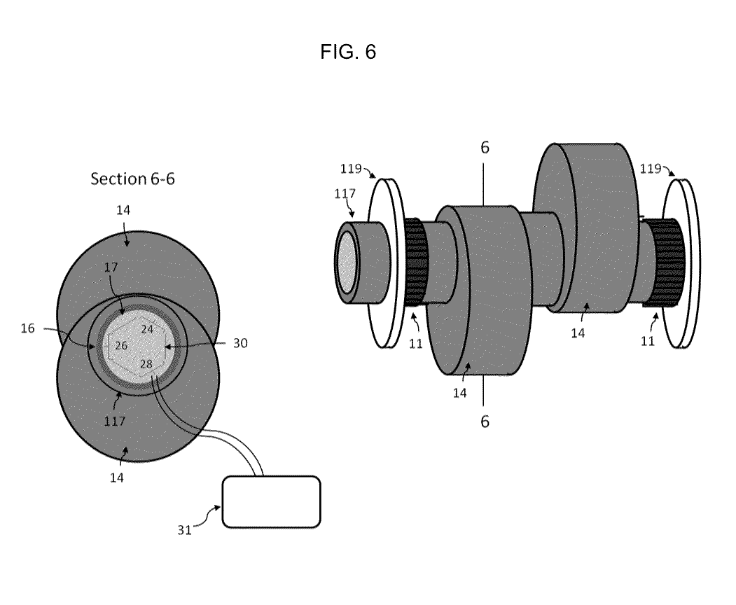

FIG. 6 is a schematic of another embodiment of an eccentric lobe assembly coupled to a crankshaft with a rotating power converter. In the illustrated embodiment, two eccentric lobes 14 are coupled to a crankshaft 117 that spins freely inside two fixed gears 11 which serve as bearing supports and around which the rotor assemblies revolve (rotary pistons not shown for viewing simplicity). In some embodiments crankshaft 117 may be configured to spin freely or be held fixed by mechanical or other means. The fixed gears 11 are mounted to the rotor housing end faces 119 (a cutaway view of the rotor housing end faces are provided for viewing simplicity). The crankshaft 117 includes magnetic element 16 which is interoperable with power converter 30 mounted to shaft 17 which may be configured to spin freely or be held fixed by mechanical or other means and induces a voltage in the power converter 30 when crankshaft 117 and shaft 17 rotate relative to one another, converting mechanical energy of the rotating converter to and from electrical energy. Power converter 30 may then use this electrical energy to charge or draw power from a battery, capacitor, or other power management system as described elsewhere herein. In the illustrated embodiment, power converter 30 may be coupled to a controller 31 while rotating using commutation (not shown) or a similar method to maintain electrical continuity between the controller 31 and power converter 30. The operation of power converter 30 is controlled by a controller 31 as described elsewhere herein.

Crankshaft 117 may, for example, act to control rotor assembly timing (rotary pistons not shown for viewing simplicity) or valve timing, may act to provide some or all of the driving force for at least one of the intake, compression, or exhaust strokes, or may convert at least a portion of the energy of the power stroke to mechanical energy to drive, for example a gear (not shown) coupled to crankshaft 117 or a differential gear assembly (not shown) that couples crankshaft 117 and shaft 17 to drive a separate drive shaft (not shown). Similarly, power converter 30 attached to shaft 17 may act, if held fixed for example, to provide some or all of the driving force for at least one of the intake, compression, or exhaust strokes, or if allowed to spin freely for example, may convert electrical energy drawn from the power management system to mechanical energy to drive, for example, a gear coupled to shaft 17 or a differential gear assembly (not shown) that couples crankshaft 117 and shaft 17 to drive a separate drive shaft (not shown). Management of this operation (fixing or releasing crankshaft 117 or shaft 17 to rotate freely) and varying the load of one or more power converters in combination with the operation of the rotary engine is controlled by controller 31 as described elsewhere herein, or by other means.

FIG. 7 illustrates a method of operating a rotary engine such as the one shown in FIG. 1 using a four-stroke rotary piston cycle with one or more revolving rotor chambers (for simplicity only two rotor chambers 114 and 116 are described herein). The power converter described elsewhere herein operates to rotate rotary piston 10, drawing reactants (e.g., a fuel-oxidizer mixture) into rotor chamber 114 as an intake stroke in which at least one reactant is brought into the engine. In some embodiments, one or more reactants may be at or near ambient pressure, and may be drawn into the cylinder by a partial vacuum produced by the piston motion in the cylinder, while in other embodiments, the reactants may be injected or otherwise introduced into the piston, for example under pressure. Reactants may be supplied in any suitable form, including without limitation as a gas or as a liquid. The power converter then operates to continue rotating rotary piston10 as a compression stroke, compressing the reactants in rotor chamber 114. A reaction between the reactants is then initiated (e.g., by a spark plug), rotating the rotary piston 10 as a power stroke. During this power stroke, the rotary piston 10 continues to rotate, exhausting any reaction products from a previous reaction in rotor chamber 116. The power converter draws power from the rotary piston 10 during power stroke, which may be stored in an energy management system as described elsewhere herein. The power converter may then rotate rotary piston 10, drawing reactants into rotor chamber 116 as an intake stroke. In some embodiments, the reactants so drawn into rotor chamber 116 may differ from those drawn into rotor chamber 114 during intake stroke in composition, proportions, temperature, or other properties, while in other embodiments, they may be substantially similar. The power converter may then operate to continue rotating rotary assembly 10 as a compression stroke for rotor chamber 116, compressing the reactants in rotor chamber 116. A reaction between the reactants is then initiated, rotating the rotary piston 10 as power stroke for rotor chamber 116. The power converter converts mechanical energy of rotary piston 10 to electrical energy during power stroke. The cycle may then be repeated.

In FIG. 7 and other figures herein, rotor assembly motions are represented schematically as constant-velocity segments. Actual rotor assembly motions will in general involve more complex velocity profiles, exhibiting continuously-changing velocities and finite accelerations. An advantage of the electromagnetic power conversion system described herein is that the coupling between the rotor assembly and the converter may be varied to optimize the velocity or acceleration at any point in the cycle, for example, to limit converter current, to control vibration, or to limit peak loads on the engine structure.

In some embodiments, drawing power from the engine electromechanically and given the shape of an epitrochoid-shaped rotor housing may allow the engine to use a power stroke with longer effective duration, or a power stroke having a different effective duration from the intake stroke, without resort to cumbersome mechanical systems. A longer power stroke duration may be more thermodynamically efficient for many engines, but has not typically been used in crankshaft engines, at least in part because it may require a larger crankshaft assembly, whose parasitic weight outstrips the increased efficiency of the longer power stroke. Unequal stroke duration may be also achieved mechanically, but such engines have typically been found to be heavy and complex as compared to crankshaft engines.

In addition, rotor assembly motion during reaction may be minutely controlled to a degree not practical with most crankshaft engines. For example, in some embodiments, it may be desirable to reduce the velocity, or even hold a rotor assembly substantially stationary until reaction is substantially complete (isochoric reaction). Power stroke may then be controlled in a configuration that optimizes power generation or that is otherwise desirable for a particular engine embodiment. For example, in some embodiments, a power stroke may be substantially isothermal or substantially adiabatic. The duration and timing of each of the four strokes of the rotary piston cycle may be varied dynamically to optimize the engine performance under varying conditions of speed, load, reactant composition, temperature, etc.

FIG. 8 is a schematic of a conventional rotary engine before being retrofitted for use with an electromagnetic converter. Before retrofitting, the engine includes two rotor housings 122, two fixed gears (not shown) fixed to two rotor housing end faces 119, one central rotor housing end face 118, two rotary pistons 10, four spark plugs 20, two intake ports 22, two exhaust ports 32, and an eccentrically, lobed crankshaft 117.

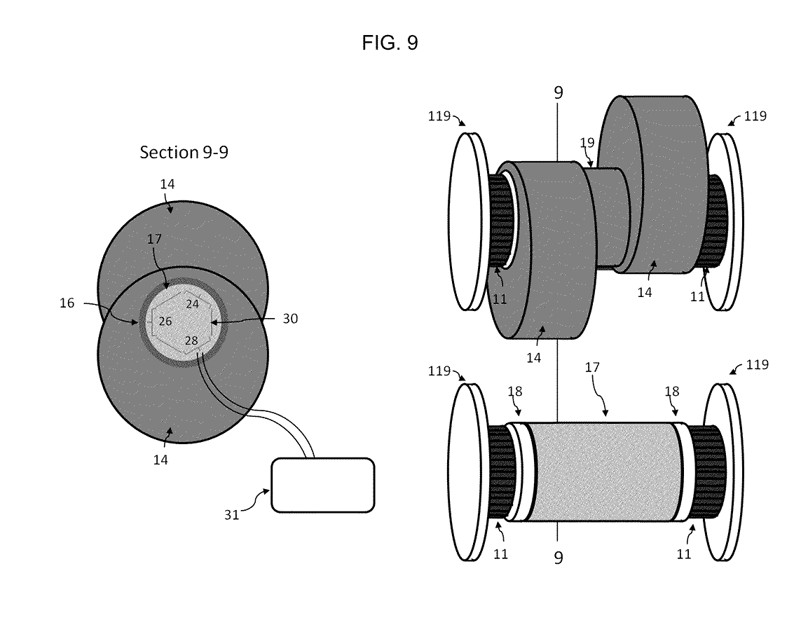

FIG. 9 is a schematic of a coupled eccentric lobe assembly and fixed shaft that can be used to retrofit a conventional rotary engine for use with an electromagnetic converter. To retrofit the engine, eccentrically lobed crankshaft 117 in FIG. 8 is removed and replaced by a fixed shaft 17 connected to fixed gears 11 with one or more power converter coils 24, 26 and 28 attached and two eccentric lobes 14 each with a magnetic element 16 that rotate freely around fixed shaft 17. In the illustrated embodiment, two rotor assemblies (not shown) rotate freely around their respective eccentric lobe 14. For each eccentric lobe 14, power converter coils 24, 26 and 28 act together as at least a component of one or more power converters 30 to apply a driving force to their associated rotor assembly during intake, compression, and exhaust strokes, and to convert mechanical energy of their associated rotary assemblies to electrical energy during their power strokes, as described elsewhere herein. In some embodiments, eccentric lobes 14 may be connected by a coupler 19 or may rotate independently. In some embodiments, power converters 30 may be electrically coupled to a switching circuit that operates to switch power converter coils 24, 26 and 28 for operation during different portions of the engine cycle, while in other embodiments, each power converter 30 may have its own switching circuit. In either case, energy from each power converter 30 may either be stored in its own associated energy management system (described elsewhere herein), or may be pooled in a common energy management system. In some embodiments, a single power converter coil may be provided for each eccentric lobe 14, or for one or more eccentric lobes 14.

In some embodiments, eccentrically lobed crankshaft 117 in FIG. 8 may be retained, in which case a different arrangement of magnetic fields and converter coils or other variable inductance or variable reluctance circuits that convert mechanical energy of the rotor assemblies to and from electrical energy may be preferred. If eccentrically lobed crankshaft 117 in FIG. 8 is retained, it serves to maintain synchronous operation of the rotor assemblies. If eccentrically lobed crankshaft 117 in FIG. 8 is removed, the rotor assemblies may be operated synchronously or asynchronously, and rotor assembly timing may be controlled by operation of the power converter(s). In some embodiments, a hybrid system many be used, in which power converters 30 are installed on only a subset of rotor assemblies. In such embodiments, it may in some cases be preferable to retain eccentrically lobed crankshaft 117 in FIG. 8 to synchronize the rotor assemblies, while in other cases, other mechanical coupling systems may be preferable. The eccentrically lobed crankshaft 117 in FIG. 8, or a portion thereof, may be retained to drive a drive train or auxiliary devices such as water pumps, oil pumps, fuel pumps, fans, or compressors, or such auxiliary devices may be powered from the power converter, for example via an energy management system as described elsewhere herein.

In some of the embodiments described herein which include crankshafts, an attached rotor assembly may move in a more complicated pattern. Such movement may generally be achieved by means such as eccentric crankshafts, crankshafts which reverse direction or change speed, or active connections between rotor assemblies and crankshaft which change their relative positions (e.g., by use of active material elements). Alternatively, crankshafts may be replaced by alternative mechanical coupling devices such as cam-and-track or swashplate mechanisms, some of which can produce arbitrarily complex patterns of motion at one or more rotor assemblies.

Embodiments depicted in the Figures include magnetic elements that move through substantially stationary coils, magnetic elements that move outside substantially stationary coils, and conductors that move through a substantially stationary magnetic field. It will be understood that each of these configurations may be used in conjunction with other rotor assembly arrangements, such as those depicted in the Figures or described in the text. In addition, those of ordinary skill in the art will recognize that other arrangements of conductors, magnetic materials, and magnetic fields may be used to convert mechanical energy to or from electrical energy in an engine. For example, Type I superconducting materials expel magnetic fields (the Meissner effect), so that a moving Type I superconductor can change the flux in a magnetic circuit, inducing currents in a converter coil. Type II superconducting materials trap magnetic fields, and may thus be used in place of permanent magnets or electromagnets in a power converter, while providing additional unique characteristics, e.g., functioning as passively-stable magnetic bearings. In general, energy may be transferred to and from the rotor assembly by any variable reluctance or variable inductance magnetic circuit.

In some embodiments, engines include permanent magnets or electromagnets. In either case, the engine may include thermal shielding, insulation, or other thermal control apparatus (e.g., a cooling system) that functions to maintain temperatures of selected engine components within a desired range. In particular, a thermal control system may act to maintain a magnetic material below its Curie temperature.

The Figures depict several different configurations of single or dual rotor housings. In some embodiments, an engine may include a plurality of rotor housings, which may be of the same or of different types. Rotor assemblies in different rotor housings may operate independently, or may be operatively coupled (e.g., mechanically coupled as by connection to a common crankshaft). In particular, an engine may include control electronics that select whether to operate a rotor assembly, and which rotor assembly to operate, in response to a determined actual or predicted operating condition (e.g., incline of the engine or of a vehicle powered by the engine, temperature, current draw, speed, acceleration, braking, load such as gross vehicle weight, fuel composition, engine emissions, power, local rules such as emissions limits, or engine settings). For example, when power draw is relatively heavy, the control electronics may run rotor assemblies more frequently or run more rotor assemblies. When power draw is relatively light, the control electronics may run fewer rotor assemblies, including not running a rotor assembly at all.

In embodiments in which the rotor assemblies are not coupled to one another in a configuration that maintains their relative phase (e.g., via connection to a common crankshaft), they may be operated synchronously or asynchronously. As used herein in connection with rotor assembly timing, the term “asynchronous” means that the rotor assemblies are operated with at least one stroke having a different duration or velocity profile from rotor housing to rotor housing, so that a constant phase relationship is not maintained between substantially simultaneous rotary cycles. Examples of asynchronous rotor assembly operation include operating two rotors assemblies at different cycle frequencies or operating one rotor assembly while leaving another substantially stationary.

In each of the illustrated embodiments, a power converter (which may include coils or another variable reluctance or variable inductance circuit) is operable with a rotor assembly to convert mechanical energy to and from electrical energy. Electromechanical engines that convert the mechanical energy of a piston-cylinder assembly to and from electrical energy are described, for example in U.S. Pat. No. 2009/0091138 which is incorporated herein by reference. In each of the illustrated embodiments, a power converter is connected to an energy management system. The energy management system operates as an energy source and sink, drawing power from the rotor assembly during the power stroke and may return power to the rotor assembly during other strokes. Power conversion systems that can accept power inputs of variable length or amplitude and convert them to supply a substantially constant voltage are described, for example in U.S. Pat. No. 4,399,499, which is incorporated herein by reference. Such conversion systems may be used to condition power intake from the engine to make it more useful for other purposes, such as for driving a vehicle. The energy management system may also accept power inputs from other sources, for example from regenerative braking systems. The energy management system may store power in an energy storage device such as a battery or a capacitor (including a supercapacitor, ultracapacitor, or hypercapacitor). U.S. Pat. No. 6,590,360, which is incorporated herein by reference, describes a switching circuit designed to transfer energy in both directions between a battery and a motor/generator that may be used for this purpose. In some embodiments, the energy management system may also power auxiliary devices such as water pumps, oil pumps, fuel pumps, fans, or compressors.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a rotor housing” should typically be interpreted to mean “at least one rotor housing”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two rotor housings,” or “a plurality of rotor housings,” without other modifiers, typically means at least two rotor housings). Furthermore, in those instances where a phrase such as “at least one of A, B, and C,”“at least one of A, B, or C,” or “an [item] selected from the group consisting of A, B, and C,” is used, in general such a construction is intended in the sense one having skill in the art would understand the convention (e.g., any of these phrases would include but not be limited to systems that have A alone, B alone, C alone, A and B together, A and C together, B and C together, and/or A, B, and C together). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-3. (canceled)

4. An internal combustion rotary engine, comprising: one or more rotary pistons slideably disposed in one or more epitrochoid-shaped rotor housings forming one or more rotor chambers between a rotary piston and a rotor housing wall; an eccentric lobe configured to spin freely around a fixed shaft or coupled to a crankshaft configured to spin freely, and passing through the center of the rotary piston configured to rotate freely inside the rotary piston, forming a rotor assembly; an intake port configured to admit a reactant to the rotor housing; an exhaust port configured to exhaust a reaction product from the rotor housing; and one or more power converters held fixed by mechanical or other means to a rotor housing, and operable with a rotor assembly to convert mechanical energy of the rotor assembly to and from electrical energy as the rotor assembly and the power converter rotate relative to one another

5. A method of operating an internal combustion rotary engine including one or more rotor assemblies slideably disposed in one or more epitrochoid-shaped housings configured to spin freely around a fixed shaft or coupled to a crankshaft configured to spin freely, and one or more power converters held fixed by mechanical or other means to a rotor housing, and operable with a rotor assembly to convert mechanical energy of the rotor to and from electrical energy, the method comprising: introducing a reactant into the rotor housing ; applying electrical energy to a power converter to rotate a rotor assembly in a rotor housing (compression); triggering a chemical reaction of the introduced reactant, thereby transforming chemical potential energy to mechanical energy of the rotor assembly; and converting the mechanical energy of the rotor assembly to and from electrical energy via the power converter as the rotor assembly and the power converter rotate relative to one another

6. The method of claim 5, further comprising determining a velocity profile or operating frequency of a rotary piston, or duration of a rotary piston stroke based at least in part on an actual or predicted operating condition.

7. The rotary engine of claim 4, further comprising: one or more rotor assemblies coupled to a crankshaft configured to spin freely or held fixed by mechanical or other means to one or more rotor housings and one or more power converters configured to spin freely or held fixed by mechanical or other means to one or more rotor housings and coupled to the crankshaft through a differential gear assembly to drive a separate drive shaft; and a controller for actuating one or more power converters and one or more rotor assemblies to be held fixed or allowed to spin freely in order to operate the entire assembly as a combined electric motor-generator with electrical input and output, or as a hybrid electric motor-internal combustion engine with mechanical output and electrical input and output, and for varying the load of one or more power converters in combination with the operation of the rotary engine.

8. The method of claim 5, further comprising one or more rotor assemblies coupled to a crankshaft configured to spin freely or held fixed by mechanical or other means to one or more rotor housings and one or more power converters configured to spin freely or held fixed by mechanical or other means to one or more rotor housings and coupled to the crankshaft through a differential gear assembly to drive a separate drive shaft, the method comprising:
actuating one or more power converters and one or more rotor assemblies to be held fixed or allowed to spin freely in order to operate the entire assembly as a combined electric motor-generator with electrical input and output or as a hybrid electric motor-internal combustion engine with mechanical output and electrical input and output, and varying the load of one or more power converters in combination with the operation of the rotary engine to optimize the energy output of the hybrid engine.

9. The rotary engine of claim 4, further comprising: a first rotary piston slideably disposed in an epitrochoid-shaped first rotor housing forming one or more rotor chambers between the first rotary piston and the first rotor housing wall; a first eccentric lobe configured to spin freely around a fixed shaft or coupled to a crankshaft configured to spin freely or held fixed by mechanical or other means to the first rotor housing, and passing through the center of the first rotary piston configured to rotate freely inside the first rotary piston, forming a first rotor assembly; a first intake port configured to admit a reactant to the first rotor housing; a first exhaust port configured to exhaust a reaction product from the first rotor housing; and a first power converter configured to spin freely or held fixed by mechanical or other means to the first rotor housing, and operable with the first rotor assembly to convert mechanical energy of the first rotor assembly to and from electrical energy as the first rotor assembly and the first power converter rotate relative to one another within a rotary piston cycle; a second rotary piston slideably disposed in an epitrochoid-shaped second rotor housing forming one or more rotor chambers between the second rotary piston and the second rotor housing wall; a second eccentric lobe configured to spin freely around a fixed shaft or coupled to a crankshaft configured to spin freely or held fixed by mechanical or other means to the second rotor housing, and passing through the center of the second rotary piston configured to rotate freely inside the second rotary piston, forming a second rotor assembly; a second power converter configured to spin freely or held fixed by mechanical or other means to the second rotor housing, and operable with the second rotor assembly to convert mechanical energy of the second rotor assembly to and from electrical energy as the second rotor assembly and the second power converter rotate relative to one another; and wherein the first and second power converters are configured to move the first and second rotor assemblies either alone or synchronously.

10. The method of claim 5, further comprising a first rotor assembly slideably disposed in a first rotor housing and a second rotor assembly slideably disposed in a second rotor housing, the method comprising: actuating the first rotary piston using a first power converter during a first rotary piston cycle; actuating the second rotary piston in a second rotor housing using a second power converter independently from actuating the first rotor assembly; and wherein the actuating the first rotor assembly and the actuating the second rotor assembly are performed either alone or synchronously.

11. The rotary engine of claim 4, further comprising: a first rotary piston slideably disposed in an epitrochoid-shaped first rotor housing forming one or more rotor chambers between the first rotary piston and the first rotor housing wall; a first eccentric lobe configured to spin freely around a fixed shaft or coupled to a crankshaft configured to spin freely or held fixed by mechanical or other means to the first rotor housing, and passing through the center of the first rotary piston configured to rotate freely inside the first rotary piston, forming a first rotor assembly; a first intake port configured to admit a reactant to the first rotor housing; a first exhaust port configured to exhaust a reaction product from the first rotor housing; and a first power converter configured to spin freely or held fixed by mechanical or other means to the first rotor housing, and operable with the first rotor assembly to convert mechanical energy of the first rotor assembly to and from electrical energy as the first rotor assembly and the first power converter rotate relative to one another within a rotary piston cycle; a second rotary piston slideably disposed in an epitrochoid-shaped second rotor housing forming one or more rotor chambers between the second rotary piston and the second rotor housing wall; a second eccentric lobe configured to spin freely around a fixed shaft or coupled to a crankshaft configured to spin freely or held fixed by mechanical or other means to the second rotor housing, and passing through the center of the second rotary piston configured to rotate freely inside the second rotary piston, forming a second rotor assembly; a second power converter configured to spin freely or held fixed by mechanical or other means to the second rotor housing, and operable with the second rotor assembly to convert mechanical energy of the second rotor assembly to and from electrical energy as the second rotor assembly and the second power converter rotate relative to one another; and wherein the first and second power converters are configured to move the first and second rotor assemblies either alone or asynchronously.

12. The method of claim 5, further comprising a first rotor assembly slideably disposed in a first rotor housing and a second rotor assembly slideably disposed in a second rotor housing, the method comprising: actuating the first rotor assembly using a first power converter during a first rotary piston cycle; actuating the second rotary piston in a second rotor housing using a second power converter independently from the actuating the first rotary piston; and wherein the actuating the first rotary piston and the actuating the second rotary piston are performed either alone or asynchronously.
